(19) United States
(12) Patent Application Publication
(10) Pub. No.: US 2013/0010507 A1
(43) Pub. Date: Jan. 10, 2013

(54) PROTECTED POWER CONVERSION DEVICE AND CONTROL METHOD

(75) Inventor: Tadayuki Kitahara, Tokyo (JP)

(73) Assignee: MERSTECH, INC., Tokyo (JP)

(21) Appl. No.: 13/517,051

(22) PCT Filed: Jan. 14, 2011
(86) PCT No.: PCT/JP2011/050583

§ 371 Date: Aug. 4, 2012

(30) Foreign Application Priority Data
Jan. 15, 2010 (JP) 2010-007487

(51) Int. Cl. H02H 7/122

(52) U.S. Cl. 363/56.03

(57) ABSTRACT

A protected power conversion device (1) includes a full-bridge MERS (100), a control circuit (200), and an ammeter (300), and is connected between a DC current source (2) and an inductive load (3). The ammeter (300) measures a current value supplied to the inductive load (3). The control circuit (200) changes the states of four reverse-conductive semiconductor switches (SW1) to (SW4) configuring the full-bridge MERS (100) to convert power output by the DC current source (2) into AC power, and supplies the AC power to the inductive load (3). When, for example, the inductive load (3) is short-circuited and malfunctions, a large current flows therethrough, and the current value detected by the ammeter (300) becomes equal to or greater than a predetermined value, the control circuit (200) turns OFF all reverse-conductive semiconductor switches (SW1) to (SW4) to cut OFF the large current.

### TECHNICAL FIELD

The present invention relates to a protected power conversion device and a control method.

### BACKGROUND ART

A full-bridge magnetic energy recovery switch (MERS: Magnetic Energy Recovery Switch) (hereinafter, referred to as a “full-bridge MERS”) is known as a device that controls a current.

A full-bridge MERS includes four reverse-conductive semiconductor switches and a capacitor. The full-bridge MERS enables a control of a current by a simple control.

Patent Literature 1 discloses a circuit that supplies an AC current to an inductive load from a DC power supply through the full-bridge MERS.

This circuit changes ON/OFF states of the four reverse-conductive semiconductor switches configuring the full-bridge MERS to cause a series resonance of the capacitor of the full-bridge MERS and the inductance of the inductive load, and supplies an AC current to the inductive load by a voltage generated at the capacitor.

### PRIOR ART LITERATURE

### Patent Literature

Patent Literature 1: Unexamined Japanese Patent Application Kokai Publication No. 2008-092745

### DISCLOSURE OF INVENTION

### Problems to be Solved by the Invention

According to the circuit disclosed in Patent Literature 1, however, when, for example, the inductive load malfunctions and is short-circuited (hereinafter, referred to as a short-circuit malfunction), a current and a voltage exceeding the rating may be supplied to the reverse-conductive semiconductor switches, and thus the reverse-conductive semiconductor switches may malfunction.

The present invention has been made in view of the above-explained technical issue, and it is an object of the present invention to provide a protected power conversion device and a control method which can prevent a reverse-conductive semiconductor switch from malfunctioning.

### Means for Solving the Problems

To achieve the above object, a first aspect of the present invention provides a protected power conversion device that includes: a magnetic energy recovery switch including first and second AC terminals, first and second DC terminals, first to fourth diode units, first to fourth switch units, and a capacitor connected between the first and second DC terminals or between the first and second AC terminals, a DC current source being connected between the first and second DC terminals, an inductive load being connected between the first and second AC terminals, an anode of the first diode unit and a cathode of the second diode unit being connected to the first AC terminal, a cathode of the first diode unit and a cathode of the third diode unit being connected to the first DC terminal, an anode of the second diode unit and an anode of the fourth diode unit being connected to the second DC terminal, an anode of the third diode unit and a cathode of the fourth diode unit being connected to the second AC terminal, the first, second, third, and fourth switch units being connected to the first, second, third, and fourth diode units, respectively, in a parallel connection manner;

a control means that changes, at a predetermined frequency, an ON/OFF state of a pair of the first and fourth switch units and an ON/OFF state of a pair of the second and third switch units so that either one pair is turned OFF when another pair is turned ON; and

a current detecting means that detects a current value flowing through the inductive load and outputs the detected current value, wherein

the control means supplies OFF signals to all of the switch units to turn OFF the all of the switch units after the current value output by the current detecting means becomes equal to or greater than a first predetermined current value.

The predetermined frequency is, for example, equal to or lower than a resonant frequency defined by an inductance of the inductive load and a capacity of the capacitor.

For example, the control means supplies the OFF signals to all of the switch units when a predetermined time has elapsed after the current value output by the current detecting means becomes equal to or greater than the first predetermined current value.

For example, the control means supplies the OFF signals to all of the switch units when the current value output by the current detecting means becomes equal to or smaller than a second predetermined current value after the current value output by the current detecting means becomes equal to or greater than the first predetermined current value.

The protected power conversion device further includes, for example, a voltage detecting means that detects a voltage between both electrodes of the capacitor, and outputs a detected voltage value,

wherein the control means supplies the OFF signals to all of the switch units when the voltage value output by the voltage detecting means becomes equal to or smaller than a predetermined voltage value after the current value output by the current detecting means becomes equal to or greater than the first predetermined current value.

For example, the control means supplies the OFF signals to all of the switch units when the voltage value output by the voltage detecting means becomes substantially zero after the current value output by the current detecting means becomes equal to or greater than the first predetermined current value.

To achieve the above object, a second aspect of the present invention provides a protected power conversion device that includes: a magnetic energy recovery switch including first and second AC terminals, first and second DC terminals, first to fourth diode units, first to fourth switch units, and a capacitor connected between the first and second DC terminals or between the first and second AC terminals, a DC current source being connected between the first and second DC terminals, an inductive load being connected between the first and second AC terminals, an anode of the first diode unit and a cathode of the second diode unit being connected to the first AC terminal, a cathode of the first diode unit and a cathode of the third diode unit being connected to the first DC terminal, an anode of the second diode unit and an anode of the fourth diode unit being connected to the second DC terminal, an anode of the third diode unit and a cathode of the fourth diode unit being connected to the second AC terminal, and the first, second, third, and fourth switch units being connected to the first, second, third, and fourth diode units, respectively, in a parallel connection manner;

a control means which changes, at a predetermined frequency, an ON/OFF state of a pair of the first and fourth switch units and an ON/OFF state of a pair of the second and third switch units so that either one pair is turned OFF when another pair is turned ON; and

a voltage detecting means which detects a voltage across both electrodes of the capacitor and which outputs a detected voltage value, wherein

the control means supplies OFF signals to all of the switch units to turn OFF the all of the switch units when a time at which the voltage value output by the voltage detecting means is substantially zero exceeds a predetermined time.

The protected power conversion device further includes, for example, a coil, in which the DC current source is a series circuit of the coil and a DC voltage source.

To achieve the above object, a third aspect of the present invention provides a control method for a magnetic energy recovery switch including first and second AC terminals, first and second DC terminals, first to fourth diode units, first to fourth switch units, and a capacitor connected between the first and second DC terminals or between the first and second AC terminals, a DC current source being connected between the first and second DC terminals, an inductive load being connected between the first and second AC terminals, an anode of the first diode unit and a cathode of the second diode unit being connected to the first AC terminal, a cathode of the first diode unit and a cathode of the third diode unit being connected to the first DC terminal, an anode of the second diode unit and an anode of the fourth diode unit being connected to the second DC terminal, an anode of the third diode unit and a cathode of the fourth diode unit being connected to the second AC terminal, the first, second, third, and fourth switch units are connected to the first, second, third, and fourth diode units, respectively, in a parallel connection manner, the method including steps of:

changing, at a predetermined frequency, an ON/OFF state of a pair of the first and fourth switch units and an ON/OFF state of a pair of the second and third switch units so that either one pair is turned OFF when another pair is turned ON, detecting a current flowing through the inductive load, and outputting a detected current value; and

supplying OFF signals to all of the switch units to turn OFF the all of the switch units after the current value becomes equal to or greater than a first predetermined current value.

To achieve the above object, a fourth aspect of the present invention provides a control method for a magnetic energy recovery switch including first and second AC terminals, first and second DC terminals, first to fourth diode units, first to fourth switch units, and a capacitor connected between the first and second DC terminals or between the first and second AC terminals, a DC current source being connected between the first and second DC terminals, an inductive load being connected between the first and second AC terminals, an anode of the first diode unit and a cathode of the second diode unit being connected to the first AC terminal, a cathode of the first diode unit and a cathode of the third diode unit being connected to the first DC terminal, an anode of the second diode unit and an anode of the fourth diode unit being connected to the second DC terminal, an anode of the third diode unit and a cathode of the fourth diode unit being connected to the second AC terminal, the first, second, third, and fourth switch units are connected to the first, second, third, and fourth diode units, respectively, in a parallel connection manner, the method including steps of:

changing, at a predetermined frequency, an ON/OFF state of a pair of the first and fourth switch units and an ON/OFF state of a pair of the second and third switch units so that either one pair is turned OFF when another pair is turned ON, detecting a voltage across both electrodes of the capacitor, and outputting a detected voltage value; and

supplying OFF signals to all of the switch units to turn OFF the all of the switch units when a time at which the voltage value is substantially zero exceeds a predetermined time.

According to the above-explained configurations, a reverse-conductive semiconductor switch is less likely to malfunction.

### BRIEF DESCRIPTION OF DRAWINGS

FIG. 1 is a diagram showing a configuration of a protected power conversion device according to an embodiment of the present invention;

FIG. 2 is a diagram showing a current pathway of the protected power conversion device shown in FIG. 1;

FIG. 3 is a diagram showing a current pathway of the protected power conversion device shown in FIG. 1;

FIG. 4 is a diagram showing a current pathway of the protected power conversion device shown in FIG. 1;

FIG. 5 is a diagram showing a current pathway of the protected power conversion device shown in FIG. 1;

FIG. 6 is a diagram showing a current pathway of the protected power conversion device shown in FIG. 1;

FIG. 7 is a diagram showing a current pathway of the protected power conversion device shown in FIG. 1;

FIG. 8 is a diagram showing a current pathway of the protected power conversion device shown in FIG. 1;

FIG. 9 is a diagram showing a current pathway of the protected power conversion device shown in FIG. 1;

FIG. 10 is a diagram showing a change in a load current and in a load voltage in accordance with an operation of the protected power conversion device shown in FIG. 1;

FIG. 11 is a diagram showing a modified example of the protected power conversion device shown in FIG. 1;

FIG. 12 is a diagram showing a modified example of the protected power conversion device shown in FIG. 1; and

FIG. 13 is a diagram showing a modified example of the protected power conversion device shown in FIG. 1.

### MODE FOR CARRYING OUT THE INVENTION

An explanation will be given of a protected power conversion device 1 according to an embodiment of the present invention with reference to the accompanying drawings.

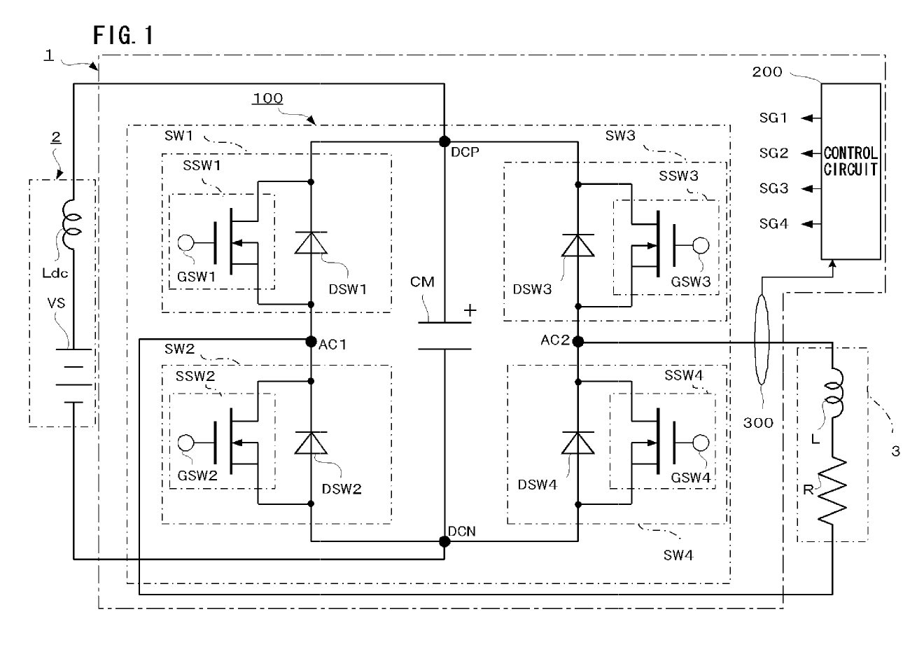

As shown in FIG. 1, the protected power conversion device 1 includes a full-bridge MERS 100, a control circuit 200, and an ammeter 300, which are connected between a DC current source 2 and an inductive load 3.

The full-bridge MERS 100 includes four reverse-conductive semiconductor switches SW1 to SW4, a capacitor CM, AC terminals AC1, AC2 (AC: Alternating Current), and DC terminals DCP, DCN (DC: Direct Current).

The reverse-conductive semiconductor switches SW1 to SW4 of the full-bridge MERS 100 include respective diode units DSW1 to DSW4 each serving as a diode, and respective switch units (in this embodiment, self-extinction elements) SSW1 to SSW4 connected in parallel with respective diode units DSW1 to DSW4. The switch units SSW1 to SSW4 include respective gates GSW1 to GSW4.

The reverse-conductive semiconductor switches SW1 to SW4 are each, for example, an N-channel silicon MOSFET (MOSFET: Metal Oxide Semiconductor Field Effect Transistor).

The DC current source 2 includes a series circuit of a coil Ldc and a DC voltage source VS. The series circuit of the coil Ldc and the DC voltage source VS is connected between the DC terminals DCP and DCN of the full-bridge MERS 100.

The inductive load 3 is connected between the AC terminals AC1 to AC2 of the full-bridge MERS 100.

The AC terminal AC1 of the full-bridge MERS 100 is connected to the anode of the diode unit DSW1 and the cathode of the diode unit DSW2. The DC terminal DCP is connected to the cathode of the diode unit DSW1, the cathode of the diode unit DSW3, and the positive electrode of the capacitor CM. The DC terminal DCN is connected to the anode of the diode unit DSW2, the anode of the diode unit DSW4, and the negative electrode of the capacitor CM. The AC terminal AC2 is connected to the anode of the diode unit DSW3 and the cathode of the diode unit DSW4.

The DC voltage source VS is, for example, a battery that outputs a DC voltage. The voltage output by the DC voltage source VS is, for example, 175 V.

The coil Ldc stably supplies the power output by the DC voltage source VS to the full-bridge MERS 100.

The coil Ldc has an inductance of, for example, 10 mH.

The inductive load 3 is an inductive load, such as an induction heating coil, or a motor, and can be expressed as a series circuit of an inductance L and a resistor R.

The ammeter 300 detects a current value of a current flowing through the inductive load 3, and outputs the detected current value to the control circuit 200. The ammeter 300 detects a current value and outputs the detected current value by, for example, outputting a voltage value corresponding to the current value flowing through the inductive load 3.

The full-bridge MERS 100 converts the current supplied from the DC terminals DCP and DCN into an AC current, and outputs the AC current between the AC terminals AC1 to AC2, by periodically changing respective ON/OFF states of the reverse-conductive semiconductor switches SW1 to SW4.

The reverse-conductive semiconductor switches SW1 to SW4 have respective ON/OFF states changed when changing of respective ON/OFF states of the switch units SSW1 to SSW4.

When inputting an ON signal to the gate GSW1, the switch unit SSW1 turns ON, and when inputting an OFF signal to the gate GSW1, the switch unit SSW1 turns OFF. The same is true of the cases of each of the reverse-conductive semiconductor switches SW2 to SW4.

When the switch unit SSW1 is in an ON state, the reverse-conductive semiconductor switch SW1 has the diode unit DSW1 short-circuited between both terminals thereof by the switch unit SSW1. When the switch unit SSW1 is in an OFF state, the diode unit DSW1 of the reverse-conductive semiconductor switch SW1 is able to function. The same is true of each of the reverse-conductive semiconductor switches SW2 to SW4.

Gate signals SG1 to SG4 output by the control circuit 200 change ON/OFF states of the reverse-conductive semiconductor switches SW1 to SW4, respectively.

The capacitor CM resonates with the internal reactance of the inductive load 3 at a resonant frequency fr. By resonating with the internal reactance of the inductive load 3, the capacitor CM accumulates and regenerates, in the form of charges, the magnetic energy accumulated in the inductive load 3. The capacitor CM has a capacity of, for example, 1.6 mF.

The control circuit 200 supplies the gate signals SG1 to SG4 to respective gates GSW1 to GSW4 of the four reverse-conductive semiconductor switches SW1 to SW4 configuring the full-bridge MERS 100. The gate signals SG1 to SG4 each include the ON signal and the OFF signal, and change the ON/OFF states of the reverse-conductive semiconductor switches SW1 to SW4, respectively.

The control circuit 200 is, for example, an electronic circuit configured by a comparator, a flip-flop, a timer, an oscillator, and the like.

The gate signals SG1 to SG4 each have a preset frequency f, and are a signal having a duty ratio of 0.5. The gate signal SG1 and the gate signal SG4, and the gate signal SG2 and the gate signal SG3 are substantially reversed-phase signals with each other. The frequency f is set to be smaller than the resonant frequency fr of the capacitor CM and the internal inductance of the inductive load 3. Since the frequency f is smaller than the resonant frequency fr, the capacitor CM temporally accumulates, as electrostatic energy, the magnetic energy accumulated in the internal reactance of the inductive load 3 during the half cycle of the frequency f, and ideally, regenerates the accumulated electrostatic energy completely.

When all reverse-conductive semiconductor switches SW1 to SW4 are turned ON simultaneously, the capacitor CM is short-circuited, and thus the gate signals SG1 to SG4 are controlled in such a way that all reverse-conductive semiconductor switches SW1 to SW4 do not turn ON simultaneously.

Moreover, the control circuit 200 supplies the OFF signals to all reverse-conductive semiconductor switches SW1 to SW4 to turn OFF all reverse-conductive semiconductor switches SW1 to SW4, when a predetermined time set in advance has elapsed after the absolute value of the current value output by the ammeter 300 exceeds a preset threshold.

For example, the control circuit 200 counts a time through a timer when the absolute value of the current value output by the ammeter 300 exceeds 300 A, and outputs the OFF signals to respective gates SW1 to SW4 after counting 2 microseconds to turn OFF all reverse-conductive semiconductor switches SW1 to SW4.

Until 2 microseconds has elapsed after the absolute value of the current value output by the ammeter 300 exceeds 300 A, the control circuit 200 does not change the gate signals SG1 to SG4 but maintains the turned-ON state of the reverse-conductive semiconductor switches and maintains the turned-OFF state of the reverse-conductive semiconductor switches.

The protected power conversion device 1 automatically cuts OFF the current supplied to the inductive load 3 by turning OFF all reverse-conductive semiconductor switches SW1 to SW4 when a current exceeding the threshold flows through the inductive load 3, thereby protecting the inductive load 3 and each element (in particular, protecting the reverse-conductive semiconductor switches SW1 to SW4). When the inductive load 3 malfunctions and is short-circuited (short-circuit malfunction), a current exceeding the rating of the reverse-conductive semiconductor switch may keep flowing through at least any one of the reverse-conductive semiconductor switches SW1 to SW4. Continuous flow of the current exceeding the rating results in the malfunction of at least any one of the reverse-conductive semiconductor switches SW1 to SW4, and in the improper ON/OFF control of at least any one of the reverse-conductive semiconductor switches SW1 to SW4. According to this embodiment, using the full-bridge MERS, DC/AC conversion is performed and a current is automatically cut OFF when a large current flows.

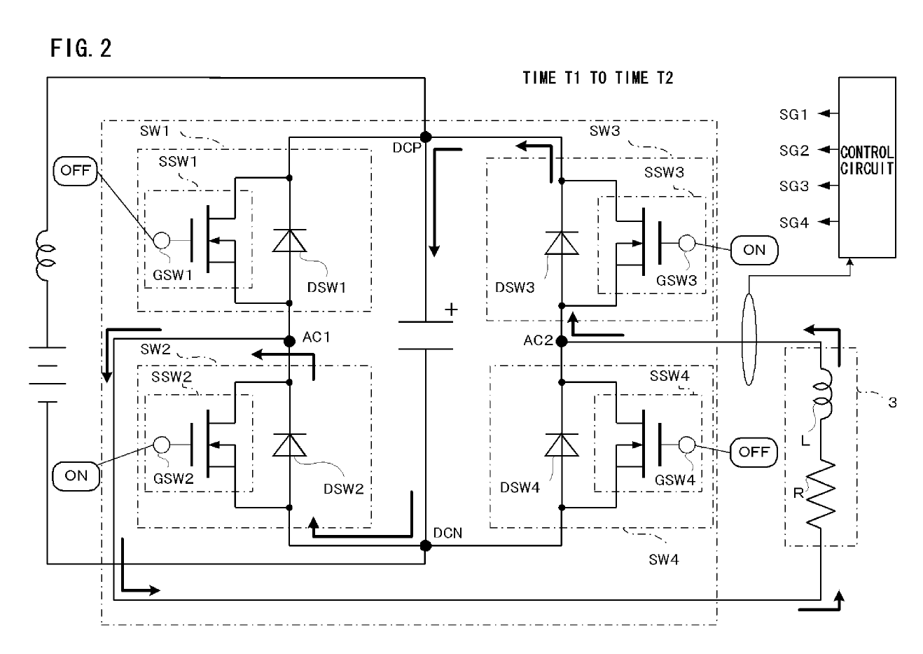

Next, an explanation will be given of a specific operation of the protected power conversion device 1 employing the above-explained configuration and a current flowing through the inductive load 3 in accordance with such an operation with reference to FIGS. 2 to 9. FIGS. 2 to 9 are diagrams for quantitatively explaining a current pathway flowing through the protected power conversion device 1. An arrow in the figures indicates a direction in which a current flows through.

The explanation will be given of an example case in which the coil Ldc has an inductance of 10 mH, the inductive load 3 has a resistance R of 0.6 Ω, the coil L has an inductance of 6 mH, the capacitor CM has a capacity of 1.6 mF, and the output by the DC voltage source is 175 V.

Moreover, the explanation will be also given of an example case in which the control circuit 200 counts a time through the timer after the current value output by the ammeter 300 exceeds 300 A, and turns OFF all reverse-conductive semiconductor switches SW1 to SW4 after 2 microseconds.

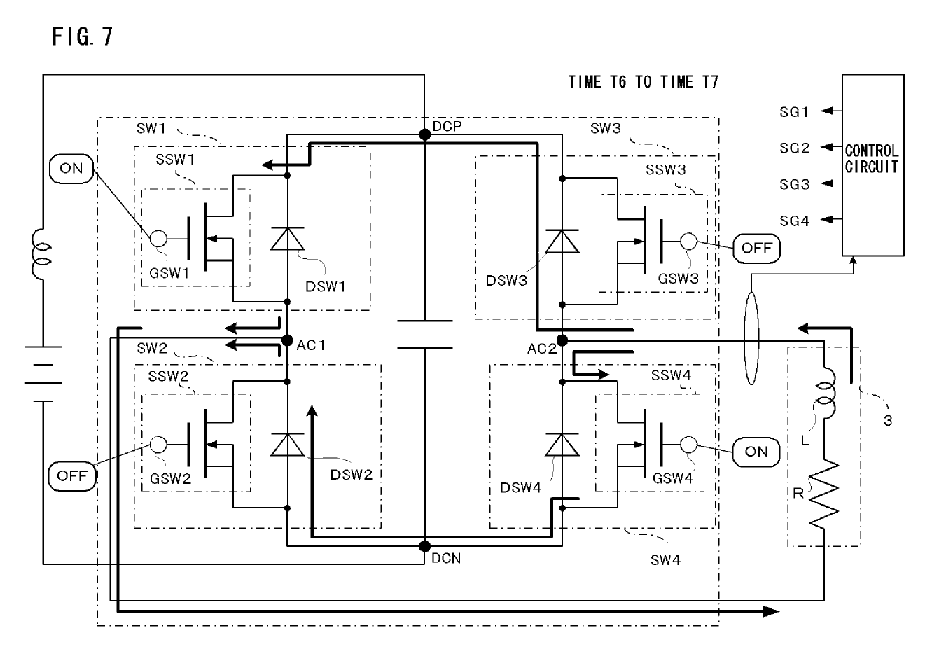

In an initial condition, the gate signals SG2 and SG3 are OFF signals, the gate signals SG1 and SG4 are ON signals, a voltage Vcm of the capacitor CM and a voltage Vload applied to the inductive load 3 are both substantially zero, and a current flows through a pathway shown in FIG. 7 to be discussed later at a time T0.

<Times T1 to T2>

At a time T1 at which the gate signals SG1 to SG4 are changed by the frequency f, the control circuit 200 changes the gate signals SG2 and SG3 to be ON signals, and changes the gate signals SG1 and SG4 to be OFF signals. The reverse-conductive semiconductor switches SW2 and SW3 are turned ON, while the reverse-conductive switches SW1 and SW4 are turned OFF.

As shown in FIG. 2, the current flows through the AC terminal AC2 from the inductive load 3, flows through the DC terminal DCP via the reverse-conductive semiconductor switch SW3 in an ON state, and flows to the positive electrode of the capacitor CM. The current flowing out from the negative electrode of the capacitor CM flows through the DC terminal DCN, flows through the AC terminal AC1 via the reverse-conductive semiconductor switch SW2 in an ON state, and flows in the inductive load 3.

<Times T2 to T3>

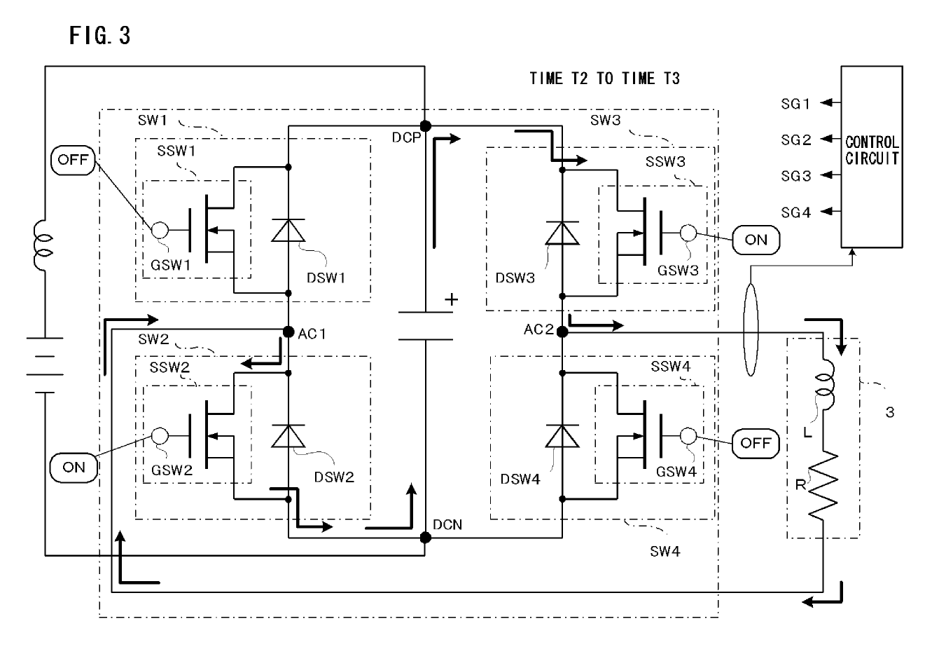

At a time T2 at which the capacitor CM completes charging by resonance, the capacitor CM starts discharging, and the current starts flowing as shown in FIG. 3. The current flows through the AC terminal AC1 from the inductive load 3, flows through the DC terminal DCN via the reverse-conductive semiconductor switch SW2 in an ON state, and flows to the negative electrode of the capacitor CM. The current flowing out from the positive electrode of the capacitor CM flows through the DC terminal DCP, flows through the AC terminal AC2 via the reverse-conductive semiconductor switch SW3 in an ON state, and flows in the inductive load 3.

<Times T3 to T4>

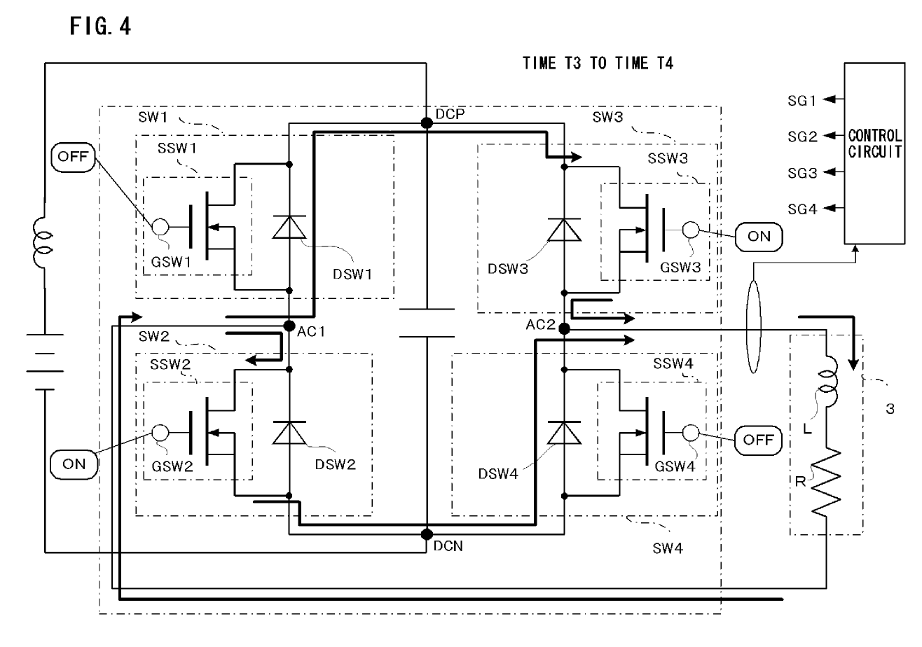

At a time T3 at which the charges of the capacitor CM become substantially zero, a voltage difference between both electrodes of the capacitor CM become substantially zero, and thus the current starts flowing as shown in FIG. 4. The current flows in the inductive load 3 through two routes: a route where the current flows through the AC terminal AC1, and flows through the AC terminal AC2 via the reverse-conductive semiconductor switch SW1 in an OFF state and the reverse-conductive semiconductor switch SW3 in an ON state; and a route where the current flows through the AC terminal AC1, and flows through the AC terminal AC2 via the reverse-conductive semiconductor switch SW2 in an ON state and the reverse-conductive semiconductor switch SW4 in an OFF state.

<Times T4 to T5>

At a time T4 at which the gate signals SG1 to SG4 are changed by the frequency f, the control circuit 200 changes the gate signals SG2 and SG3 to be OFF signals, and changes the gate signals SG1 and SG4 to be ON signals. Hence, the reverse-conductive semiconductor switches SW2 and SW3 are turned OFF, while the reverse-conductive semiconductor switches SW1 and SW4 are turned ON.

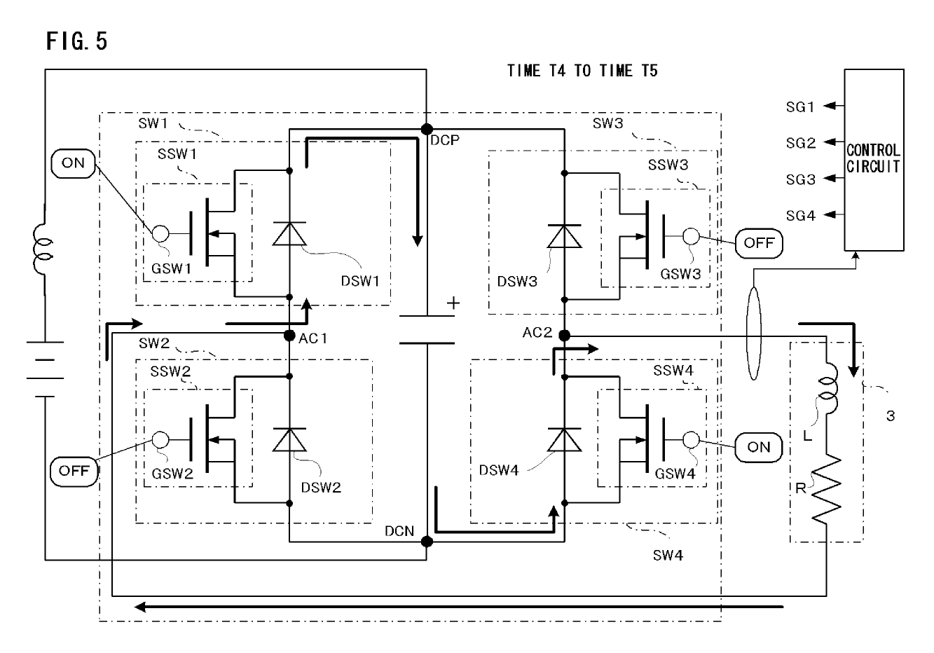

The current flows as shown in FIG. 5. The current flows through the AC terminal AC1 from the inductive load 3, flows through the DC terminal DCP via the reverse-conductive semiconductor switch SW1 in an ON state, and flows to the positive electrode of the capacitor CM. The current flowing out from the negative electrode of the capacitor CM flows through the DC terminal DCN, flows through the AC terminal AC1 via the reverse-conductive semiconductor switch SW4 in an ON state, and flows in the inductive load 3.

<Times T5 to T6>

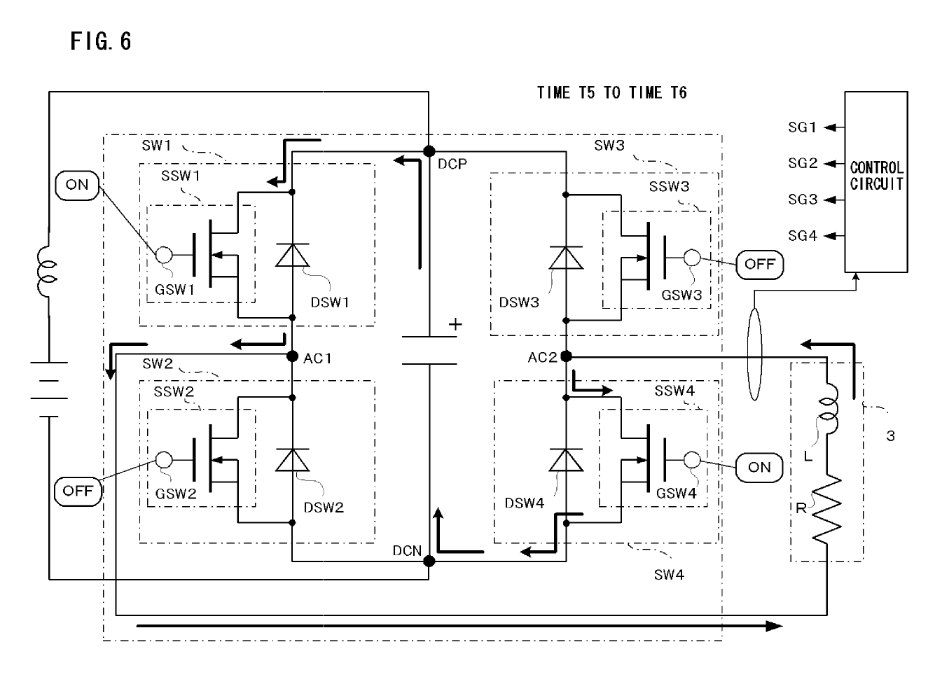

At a time T5 at which the capacitor CM completes charging by resonance, the capacitor CM starts discharging, and the current flows as shown in FIG. 6. The current flows through the AC terminal AC2 from the inductive load 3, flows through the DC terminal DCN via the reverse-conductive semiconductor switch SW4 in an ON state, and flows to the negative electrode of the capacitor CM.

The current flowing out from the positive electrode of the capacitor CM flows through the DC terminal DCP, flows through the AC terminal AC1 via the reverse-conductive semiconductor switch SW1 in an ON state, and flows in the inductive load 3.

<Times T6 to T7>

At a time T6 at which the charges of the capacitor CM become substantially zero, a voltage difference between both electrodes of the capacitor CM become substantially zero, and the current starts flowing as shown in FIG. 7. The current flows in the inductive load 3 through two routes: a route where the current flows through the AC terminal AC2, and flows through the AC terminal AC1 via the reverse-conductive semiconductor switch SW3 in an OFF state and the reverse-conductive semiconductor switch SW1 in an ON state; and a route where the current flows through the AC terminal AC2 and flows through the AC terminal AC1 via the reverse-conductive semiconductor switch SW4 in an ON state and the reverse-conductive semiconductor switch SW2 in an OFF state.

<Times T7 to T8>

At a time T7 at which the gate signals SG1 to SG4 are changed by the frequency f, the control circuit 200 changes the gate signals SG2 and SG3 again to be ON signals, and changes the gate signals SG1 and SG4 to be OFF signals. The current flows again through the pathway shown in FIG. 2.

By repeating the above-explained operations, the protected power supply device 1 supplies the AC current to the inductive load 3.

It is presumed that at a time T8 the inductive load 3 causes, for example, metal short-circuiting, and the resistor R and the inductance L are short-circuited.

At the time T8, for example, the gate signals SG2 and SG3 are ON signals, the gate signals SG1 and SG4 are OFF signals, a voltage is generated at the capacitor CM, and a load current Iload is a positive current.

When the inductive load 3 is short-circuited, the voltage drop caused by the resistor R of the inductive load 3 is cancelled, and the amount of load current Iload flowing through the load once sharply increases. The load current Iload is a total of a current Ia flowing upon releasing of the charge accumulated in the capacitor CM, a current Ib flowing upon releasing of the magnetic energy accumulated in a wiring inductance in the circuit, and a current Ic flowing from the DC current source 2.

The current Ia due to the charge accumulated in the capacitor CM stops to flow within a short time upon short-circuiting of the capacitor CM, and the resonance will be dissipated.

The current Ib flowing because of the magnetic energy accumulated in the wiring inductance in the circuit becomes not to flow within a short time since the wiring inductance is small.

Hence, the amount of load current Iload once sharply increases, but also sharply decreases. That is, once the inductive load 3 is short-circuited, a large current flows for a moment in the protected power conversion device 1. Since this large current flows only for a moment, no current exceeding the rating keeps flowing through at least any one of the reverse-conductive semiconductor switches SW1 to SW4 at this stage, and the reverse-conductive semiconductor switches SW1 to SW4 are less likely to malfunction at this stage.

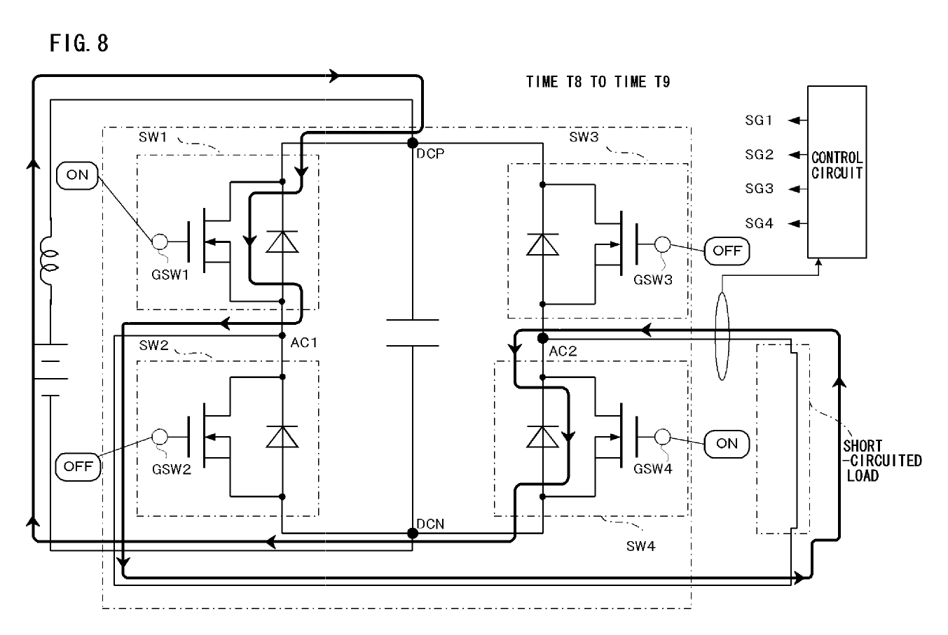

The current Ic flowing through the short-circuited inductive load 3 from the DC current source 2 flows through a pathway shown in FIG. 8. The current output by the DC current source 2 flows through the DC terminal DCP, flows through the AC terminal AC1 via the reverse-conductive semiconductor switch SW1 in an ON state, flows through the AC terminal AC2 via the short-circuited inductive load 3, flows through the DC terminal DCN via the reverse-conductive semiconductor switch SW4 in an ON state, and returns to the DC current source 2.

The current Ic flowing through the malfunctioned inductive load 3 from the DC current source 2 is generated at a time point at which the inductive load 3 has caused a short-circuit malfunction, and increases by an increment dIload/dt expressed by the following formula.

dIload/dt=Ed/Lldc

(where Ed is a voltage output by the DC voltage source VS and Lldc is an inductance of the coil Ldc)

That is, the increment of the current Ic per a unit time can be controlled by the inductance Lldc of the coil Ldc. When the inductance Lldc is small, the current Ic sharply increases, but when the inductance Lldc is large, the current Ic gently increases. Hence, the large inductance Lldc of the coil Ldc prevents a large current not for a moment from flowing again within a short time after the inductive load 3 has caused a short-circuit malfunction, the reverse-conductive semiconductor switches SW1 to SW4 from malfunctioning, and the ON/OFF states from becoming uncontrollable.

According to this embodiment, Ed is 175 V and Lldc is 10 mH, so that the current Ic becomes substantially 35 mA within two microseconds after the inductive load 3 has been short-circuited. At this time, no currents Ia and Ib becomes to flow (i.e., the above-explained large current for a moment does not flow), and the current flowing in the full-bridge MERS 100 is merely 35 mA by what corresponds to the current Ic.

The control circuit 200 counts a time through the timer when the absolute value of the current value detected by the ammeter 300 exceeds 300 A, i.e., when a large current flows. The control circuit 200 changes all gate signals SG1 to SG4 to be OFF signals at a time T9 at which the timer has counted two microseconds. In this case, when an amount of current flowing through the reverse-conductive semiconductor switches SW1 to SW4 is large, there is a possibility that the reverse-conductive semiconductor switches SW1 to SW4 do not turn OFF even if the OFF signals are supplied thereto, respectively.

As explained above, according to this embodiment, the current flowing through the reverse-conductive semiconductor switches SW1 to SW4 after two microseconds has elapsed from the short-circuit malfunction is only the current Ic, which is merely 35 mA. Accordingly, all reverse-conductive semiconductor switches SW1 to SW4 can turn OFF when the OFF signals are supplied thereto, respectively. Accordingly, the current supplied to the inductive load 3 from the DC voltage source VS through the coil Ldc is cut OFF by the full-bridge MERS 100.

According to conventional voltage inverters, no structural element serving as the coil Ldc is provided, and thus the amount of currents generated due to a short-circuit malfunction becomes very large within a short time. Even if the current is cut OFF at a time point at which the short-circuit malfunction occurs, a large current flows until the ON/OFF state of each switching device changes, which may exceed the current capacity of each switching device. Hence, a current cut-OFF control depending ON a current value is not suitable for conventional voltage inverters.

According to this embodiment, since the internal inductance and the coil Ldc of the DC current source are provided, a short-circuit current once sharply increases and decreases, and then increases gently. Hence, excessive current supply due to the short-circuit malfunction can be surely prevented.

According to the above-explained operations, the protected power conversion device 1 supplies AC power to the inductive load 3, and when, for example, a large current flows through the inductive load 3 due to a short-circuit malfunction, supplies the OFF signals to the reverse-conductive semiconductor switches SW1 to SW4 at a timing at which the current becomes small thereafter, thereby precisely cutting OFF a current supplied to the inductive load 3.

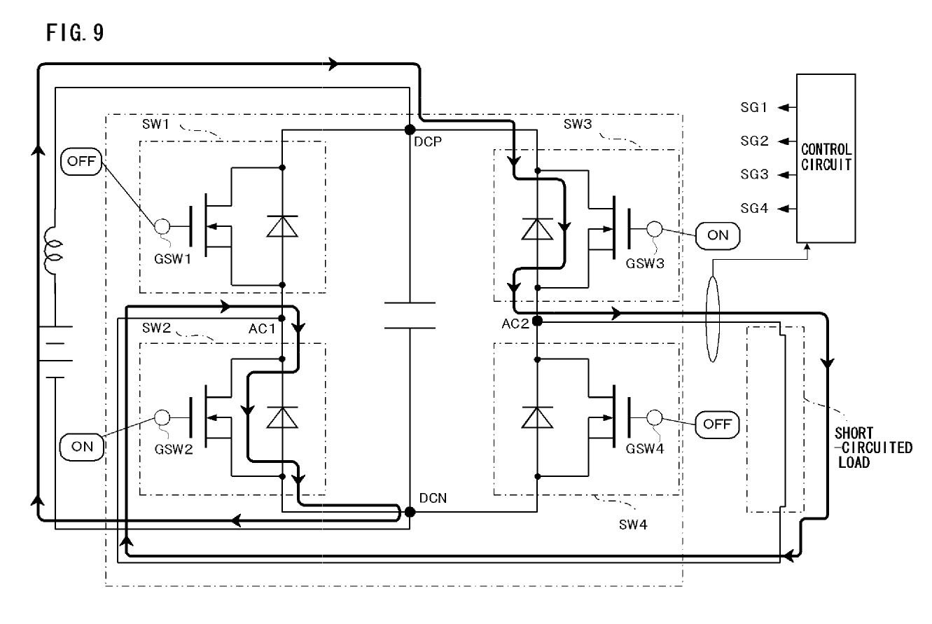

When the reverse-conductive semiconductor switches SW1 and SW4 are turned OFF and the reverse-conductive semiconductor switches SW2 and SW3 are turned ON, if the inductive load 3 causes a short-circuit malfunction, a current flowing through the short-circuit inductive load 3 from the DC current source 2 via the coil Ldc flows as shown in FIG. 9. The current output by the DC current source 2 flows through the DC terminal DCP, flows through the AC terminal AC2 via the reverse-conductive semiconductor switch SW3 in an ON state, flows through the AC terminal AC1 via the short-circuited inductive load 3, flows through the DC terminal DCN via the reverse-conductive semiconductor switch SW2 in an ON state, and returns to the DC current source 2.

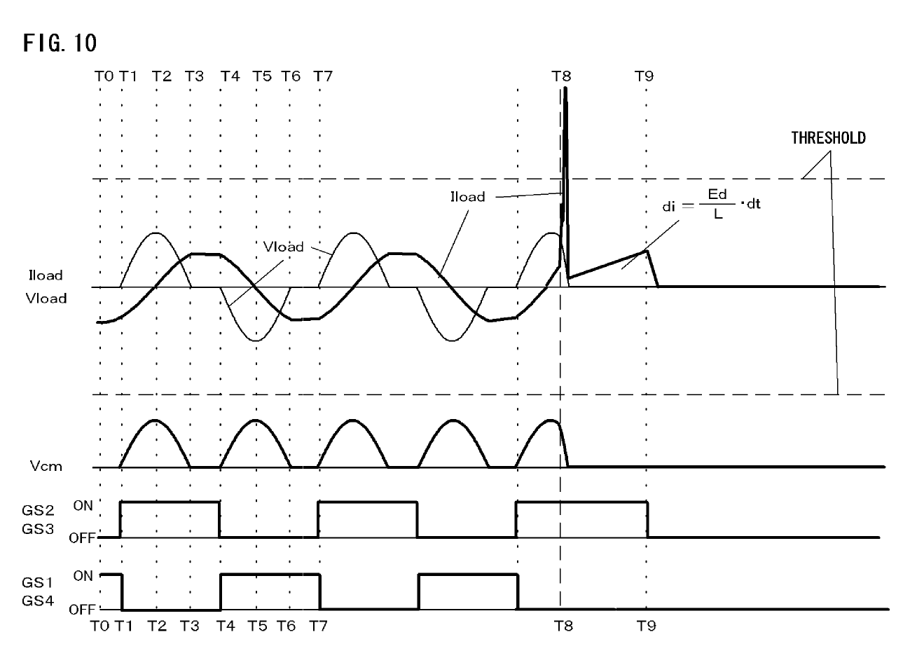

FIG. 10 is a conceptual diagram showing a relationship among the load current Iload flowing through the inductive load 3, the load voltage Vload applied thereto, the voltage Vcm of the capacitor CM, and the gate signals SG1 to SG4 when the protected power conversion device 1 employing the above-explained configuration is activated. It is presumed that the direction of the current Iload flowing through the inductive load 3 from the AC terminal AC1 to the AC terminal AC2 through the inductive load 3 is positive, and the load voltage Vload applied to the inductive load 3 is a potential of the AC terminal AC1 relative to the AC terminal AC2. However, in order to facilitate understanding, FIG. 10 shows the period from the time T8 to the time T9 in an enlarged manner along the time axis direction.

From the time T0 to the time T8, as explained above, in accordance with a change in the gate signals SG1 to SG4, charging/discharging of the capacitor voltage Vcm is repeated, the capacitor voltage Vcm is applied to the inductive load 3 as the load voltage Vload, and an AC current flows through the inductive load 3.

At the time T8, the inductive load 3 is short-circuited, and at the time T9 at which substantially two microseconds has elapsed after the load current Iload exceeds the threshold, the gate signals SG1 to SG4 become OFF signals, and the load current Iload is automatically cut OFF.

As explained above, the protected power conversion device 1 is connected to the DC current source, which enables the protected power conversion device to supply AC power to the inductive load, such as a motor or an induction heating device, and when a large current flows through the inductive load (i.e., when the current exceeds the threshold), the OFF signals are supplied to respective reverse-conductive semiconductor switches SW1 to SW4 after the current has exceeded the threshold, i.e., the OFF signals are supplied to respective reverse-conductive semiconductor switches SW1 to SW4 when a current flowing through at least one of the reverse-conductive semiconductor switches SW1 to SW4 decreases after having increased once. Accordingly, the reverse-conductive semiconductor switches SW1 to SW4 can be turned OFF, thereby cutting OFF the current. Hence, the current flowing in the full-bridge MERS 100 is cut OFF, and a large current hardly flows through at least one of the reverse-conductive semiconductor switches SW1 to SW4 configuring the full-bridge MERS 100, thereby a malfunction is less likely to occur due to such a large current.

Moreover, since the OFF signals are supplied to respective gates SW1 to SW4 when two microseconds has elapsed after the current exceeds the threshold, the discharging by the capacitor CM has already completed, and an amount of the currents cut OFF by the reverse-conductive semiconductor switches SW1 to SW4 is little. Hence, the protected power conversion device 1 can safely shut down the circuit.

Various modifications are possible to carry out the present invention.

For example, according to the above-explained embodiment, the explanation was given of the case in which the reverse-conductive semiconductor switches SW1 to SW4 are each the N-channel MOSFET having the switch unit and a parasitic diode. However, the reverse-conductive semiconductor switches SW1 to SW4 each may be a reverse-conductive switch including a switch unit that changes ON/OFF states in accordance with an ON signal and an OFF signal and a diode unit, such as a field-effect transistor, an insulated gate bipolar transistor (IGBT: Insulated Gate Bipolar Transistor), a gate turn-OFF thyristor (GTO: Gate Turn-OFF thyristor), or a combination of a diode and a switch.

Moreover, according to the above-explained embodiment, when the current supplied to the inductive load 3 exceeds the threshold, the control circuit 200 turns OFF all reverse-conductive semiconductor switches SW1 to SW4 after two microseconds has elapsed, but such a time is not limited to two microseconds.

For example, it may be after 5 microseconds or 10 microseconds, and may be adjustable.

Moreover, in the protected power conversion device 1 shown in FIG. 1, after the current value detected by the ammeter 300 and supplied to the inductive load 3 exceeds the threshold, when the current value detected by the ammeter 300 becomes equal to or smaller than a predetermined current value, the control circuit 200 may turn OFF all reverse-conductive semiconductor switches SW1 to SW4. For example, after the ammeter detects a current exceeding 300 A, when this current becomes equal to or smaller than 1 A, the control circuit 200 may output OFF signals to the reverse-conductive semiconductor switches SW1 to SW4, respectively. Accordingly, the OFF signals are supplied to respective reverse-conductive semiconductor switches SW1 to SW4 when a current flowing through at least one of the reverse-conductive semiconductor switches SW1 to SW4 becomes equal to or smaller than the rating, and thus those reverse-conductive semiconductor switches can be precisely turned OFF.

Moreover, according to the above-explained embodiment, the explanation was given of the example case in which the inductive load 3 is completely short-circuited, but the present invention can be applied to a case in which the inductive load 3 is partially short-circuited by adjusting the threshold.

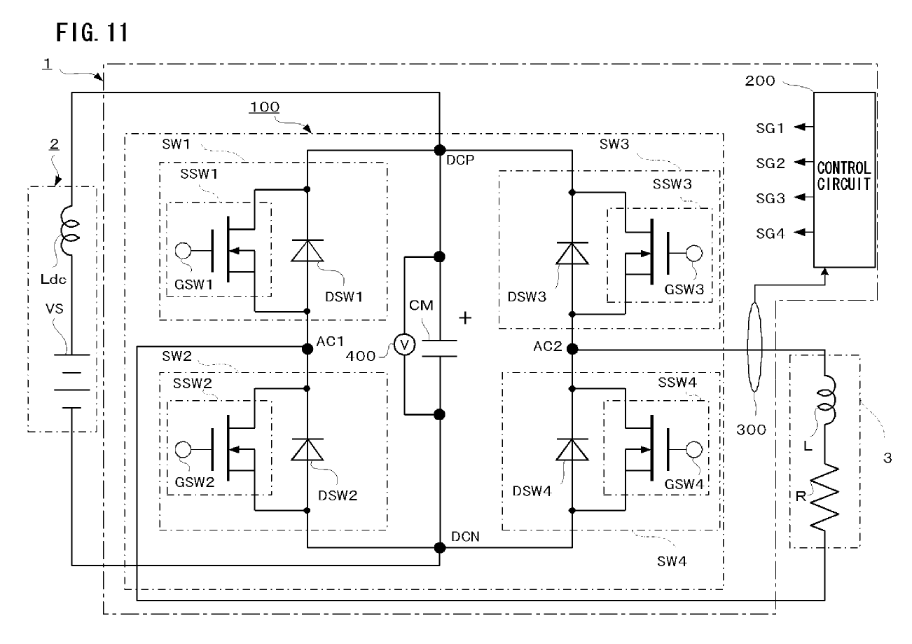

Furthermore, as shown in FIG. 11, a voltmeter 400 that detects a voltage across both electrodes of the capacitor CM may be connected, and when a voltage value detected by the voltmeter 400 becomes equal to or smaller than a predetermined voltage value after the current value detected by the ammeter 300 exceeds the threshold, the control circuit 200 may turn OFF all reverse-conductive semiconductor switches SW1 to SW4.

In this case, in accordance with the voltage across both electrodes of the capacitor CM which becomes, in particular, substantially zero, the control circuit 200 may turn OFF all reverse-conductive semiconductor switches SW1 to SW4.

When a predetermined time has elapsed and the voltage value detected by the voltmeter 400 becomes equal to or smaller than a predetermined voltage value after the current value detected by the ammeter 300 exceeds the threshold, the control circuit 200 may turn OFF all reverse-conductive semiconductor switches SW1 to SW4.

According to those methods, when a current flowing through at least one of the reverse-conductive semiconductor switches SW1 to SW4 is small, the OFF signals are supplied to respective reverse-conductive semiconductor switches SW1 to SW4, and thus those reverse-conductive semiconductor switches SW1 to SW4 can be precisely turned OFF.

Moreover, when the inductive load 3 is completely short-circuited, the coil L of the inductive load 3 and the capacitor CM no longer resonate with each other so that after the capacitor CM has discharged, no electric charge will be accumulated again. Accordingly, when the voltage value measured by the voltmeter 400 maintains a condition to be substantially zero for equal to or longer than a certain time regardless of the current value detected by the ammeter 300, the control circuit 200 may turn OFF all reverse-conductive semiconductor switches SW1 to SW4. This makes it possible for the control circuit to supply the OFF signals to the reverse-conductive semiconductor switches SW1 to SW4, respectively, when a current flowing through at least one of the reverse-conductive semiconductor switches SW1 to SW4 is small. Thus those reverse-conductive semiconductor switches can be precisely turned OFF.

This enables the protected power conversion device to automatically cut OFF the power supply to the inductive load 3 when the inductive load 3 is completely short-circuited. If the short-circuit malfunction occurs when no charge is accumulated in the capacitor CM, there is a possibility that the load current Iload does not become equal to or higher than a predetermined voltage value, and thus this method is more effective for the case in which the inductive load 3 is completely short-circuited.

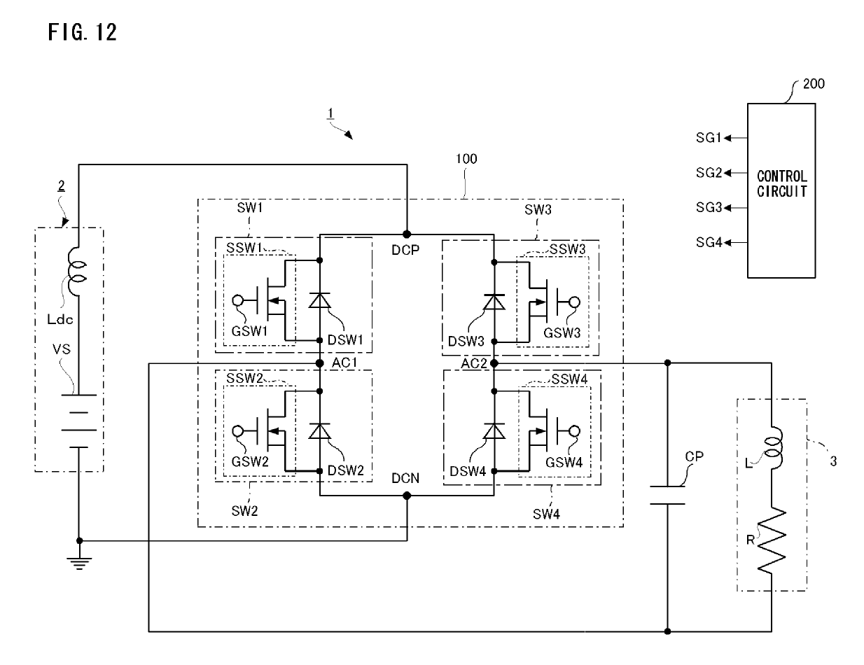

Furthermore, as shown in FIG. 12, in the full-bridge MERS 100, instead of the capacitor CM disposed between the DC terminals DCP and DCN, a non-polar capacitor CP may be connected between the AC terminals AC1 and AC2. No modification is necessary for the gate signals, etc.

Together with the change in the ON/OFF states of the reverse-conductive semiconductor switches SW1 to SW4 of the full-bridge MERS 100, the inductor L and the capacitor CP repeat resonating with each other by power supplied from the current source 2 through the AC terminal AC1 or AC2.

In this case, the resonance in the pathways explained with reference to FIGS. 2 to 7 is repeated without through the reverse-conductive semiconductor switches SW1 to SW4, and thus respective current loads to the reverse-conductive semiconductor switches SW1 to SW4 can be reduced. This results in the extension of the lifetimes of respective reverse-conductive semiconductor switches SW1 to SW4.

Needless to say, both capacitor CP and capacitor CM may be provided. In this case, the resonant frequency is defined by the synthesized capacity of the capacitor CM and the capacitor CP, and the inductance of the inductor L.

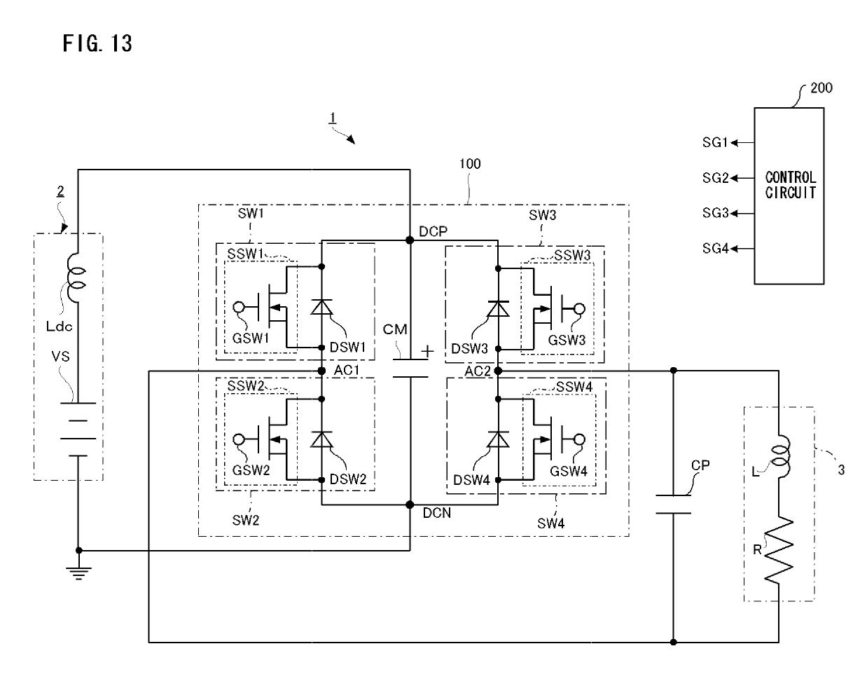

Furthermore, as shown in FIG. 13, both capacitor CM and capacitor CP may be provided.

The explanation was given of the case in which the control circuit 200 is an electronic circuit for the above-explained control operation, but the control circuit may be a computer like a micro controller (hereinafter, referred to as a “micon”) including a CPU (Central Processing Unit), and memory means, such as a RAM (Random Access Memory), and a ROM (Read Only Memory).

In particular, when the control circuit 200 is realized by a micon, if the reverse-conductive semiconductor switches and the micon are combined in such a way that the reverse-conductive semiconductor switches turn ON and OFF in accordance with signals of 1 and 0 output by the micon, the ON/OFF states of the reverse-conductive semiconductor switches can be changed by the output of the micon, and thus the number of components can be reduced.

In this case, for example, a program for outputting gate signals as explained above may be stored in advance in the micon.

A program for causing a computer to execute the above-explained control operation and stored in a computer-readable recording medium, such as a flexible disk, a CD-ROM (Compact Disc-Read Only Memory), a DVD (Digital Versatile Disk), or an MO (Magnet Optical Disk), may be distributed, and installed in another computer to cause this computer to operate as the above-explained means, or to execute the above-explained processes.

The program may be stored in an external memory device, etc., of a server device ON the Internet, and the program may be, for example, downloaded to a computer while being superimposed ON, for example, carrier waves.

Various embodiments and modifications can be made to the present invention without departing from the broad scope and spirit of the present invention. The above-explained embodiments are given to explain the present invention, and are not to limit the scope and spirit of the present invention.

This application is based on Japanese Patent Application No. 2010-007487 filed on Jan. 15, 2010. The entire specification, claims, and drawings of such an application are herein incorporated in this specification by reference.

### DESCRIPTION OF REFERENCE NUMERALS

1 Protected power conversion device
2 DC current source
3 Inductive load
100 Full-bridge MERS
200 Control circuit
300 Ammeter
400 Voltmeter
VS DC voltage source
L Inductance
Ldc Coil
R Resistor
AC1, AC2 AC terminal
DCP, DCN DC terminal
SW1, SW2, SW3, SW4 Reverse-conductive semiconductor switch
DSW1, DSW2, DSW3, DSW4 Diode unit
SSW1, SSW2, SSW3, SSW4 Switch unit
GSW1, GSW2, GSW3, GSW4 Gate
CM, CP Capacitor

1. A protected power conversion device comprising:
a magnetic energy recovery switch including first and second AC terminals, first and second DC terminals, first to fourth diode units, first to fourth switch units, and a capacitor connected between the first and second DC terminals or between the first and second AC terminals, a DC current source being connected between the first and second DC terminals, an inductive load being connected between the first and second AC terminals, an anode of the first diode unit and a cathode of the second diode unit being connected to the first AC terminal, a cathode of the first diode unit and a cathode of the third diode unit being connected to the first DC terminal, an anode of the second diode unit and an anode of the fourth diode unit being connected to the second DC terminal, an anode of the third diode unit and a cathode of the fourth diode unit being connected to the second AC terminal, the first, second, third, and fourth switch units being connected to the first, second, third, and fourth diode units, respectively, in a parallel connection manner;
a control means that changes, at a predetermined frequency, an ON/OFF state of a pair of the first and fourth switch units and an ON/OFF state of a pair of the second and third switch units so that either one pair is turned OFF when another pair is turned ON; and
a current detecting means that detects a current value flowing through the inductive load and outputs the detected current value, wherein
the control means supplies OFF signals to all of the switch units to turn OFF the all of the switch units after the current value output by the current detecting means becomes equal to or greater than a first predetermined current value.

2. The protected power conversion device according to claim 1, wherein the predetermined frequency is equal to or lower than a resonant frequency defined by an inductance of the inductive load and a capacity of the capacitor.

3. The protected power conversion device according to claim 1, wherein the control means supplies the OFF signals to all of the switch units when a predetermined time has elapsed after the current value output by the current detecting means becomes equal to or greater than the first predetermined current value.

4. The protected power conversion device according to claim 1, wherein the control means supplies the OFF signals to all of the switch units when the current value output by the current detecting means becomes equal to or smaller than a second predetermined current value after the current value output by the current detecting means becomes equal to or greater than the first predetermined current value.

5. The protected power conversion device according to claim 1, further comprising a voltage detecting means that detects a voltage between both electrodes of the capacitor, and outputs a detected voltage value,
wherein the control means supplies the OFF signals to all of the switch units when the voltage value output by the voltage detecting means becomes equal to or smaller than a predetermined voltage value after the current value output by the current detecting means becomes equal to or greater than the first predetermined current value.

6. The protected power conversion device according to claim 5, wherein the control means supplies the OFF signals to all of the switch units when the voltage value output by the voltage detecting means becomes substantially zero after the current value output by the current detecting means becomes equal to or greater than the first predetermined current value.

7. A protected power conversion device comprising:
a magnetic energy recovery switch including first and second AC terminals, first and second DC terminals, first to fourth diode units, first to fourth switch units, and a capacitor connected between the first and second DC terminals or between the first and second AC terminals, a DC current source being connected between the first and second DC terminals, an inductive load being connected between the first and second AC terminals, an anode of the first diode unit and a cathode of the second diode unit being connected to the first AC terminal, a cathode of the first diode unit and a cathode of the third diode unit being connected to the first DC terminal, an anode of the second diode unit and an anode of the fourth diode unit being connected to the second DC terminal, an anode of the third diode unit and a cathode of the fourth diode unit being connected to the second AC terminal, and the first, second, third, and fourth switch units being connected to the first, second, third, and fourth diode units, respectively, in a parallel connection manner;
a control means which changes, at a predetermined frequency, an ON/OFF state of a pair of the first and fourth switch units and an ON/OFF state of a pair of the second and third switch units so that either one pair is turned OFF when another pair is turned ON; and
a voltage detecting means which detects a voltage across both electrodes of the capacitor and which outputs a detected voltage value, wherein
the control means supplies OFF signals to all of the switch units to turn OFF the all of the switch units when a time at which the voltage value output by the voltage detecting means is substantially zero exceeds a predetermined time.

8. The protected power conversion device according to claim 1, further comprising a coil,
wherein the DC current source is a series circuit of the coil and a DC voltage source.

9. A control method for a magnetic energy recovery switch including first and second AC terminals, first and second DC terminals, first to fourth diode units, first to fourth switch units, and a capacitor connected between the first and second DC terminals or between the first and second AC terminals, a DC current source being connected between the first and second DC terminals, an inductive load being connected between the first and second AC terminals, an anode of the first diode unit and a cathode of the second diode unit being connected to the first AC terminal, a cathode of the first diode unit and a cathode of the third diode unit being connected to the first DC terminal, an anode of the second diode unit and an anode of the fourth diode unit being connected to the second DC terminal, an anode of the third diode unit and a cathode of the fourth diode unit being connected to the second AC terminal, the first, second, third, and fourth switch units are connected to the first, second, third, and fourth diode units, respectively, in a parallel connection manner, the method comprising steps of:
changing, at a predetermined frequency, an ON/OFF state of a pair of the first and fourth switch units and an ON/OFF state of a pair of the second and third switch units so that either one pair is turned OFF when another pair is turned ON, detecting a current flowing through the inductive load, and outputting a detected current value; and
supplying OFF signals to all of the switch units to turn OFF the all of the switch units after the current value becomes equal to or greater than a first predetermined current value.

10. A control method for a magnetic energy recovery switch including first and second AC terminals, first and second DC terminals, first to fourth diode units, first to fourth switch units, and a capacitor connected between the first and second DC terminals or between the first and second AC terminals, a DC current source being connected between the first and second DC terminals, an inductive load being connected between the first and second AC terminals, an anode of the first diode unit and a cathode of the second diode unit being connected to the first AC terminal, a cathode of the first diode unit and a cathode of the third diode unit being connected to the first DC terminal, an anode of the second diode unit and an anode of the fourth diode unit being connected to the second DC terminal, an anode of the third diode unit and a cathode of the fourth diode unit being connected to the second AC terminal, the first, second, third, and fourth switch units are connected to the first, second, third, and fourth diode units, respectively, in a parallel connection manner, the method comprising steps of:
changing, at a predetermined frequency, an ON/OFF state of a pair of the first and fourth switch units and an ON/OFF state of a pair of the second and third switch units so that either one pair is turned OFF when another pair is turned ON, detecting a voltage across both electrodes of the capacitor, and outputting a detected voltage value; and
supplying OFF signals to all of the switch units to turn OFF the all of the switch units when a time at which the voltage value is substantially zero exceeds a predetermined time.
